(19) United States
(12) Patent Application Publication
(10) Pub. No.: US 2004/0111404 A1
(43) Pub. Date: Jun. 10, 2004

(54) Method and system for searching text portions based upon occurrence in a specific area

(76) Inventors: Hiroko Mano, Tokyo (JP); Hideo Itoh, Tokyo (JP)

Correspondence Address: KNOBLE & YOSHIDA, LLC, Eight Penn Center, Suite 1350, 1628 John F. Kennedy Blvd., Philadelphia, PA, 19103, US

(21) Appl. No.: 10/650,444

(22) Filed: Aug. 28, 2003

(30) Foreign Application Priority Data
Aug. 29, 2002 (JP) 2002-250281

(51) Int. Cl. G06F 17/30

(52) U.S. Cl. 707/3

(57) ABSTRACT

A text processor or text processing software determines a significance value of a search word based upon the word occurrence in a specified part of a predetermined text database. After a search request is inputted and parsed, each of the search word candidates is searched in a specified portion of the predetermined text database. For example, a search word candidate is searched only in a near portion or area of the predetermined text database to determine its specific area occurrence value. The above determined specific area occurrence value is used in the subsequent steps or tasks to accomplish a desired task.

### FIELD OF THE INVENTION

The current invention is generally related to text processing, and more particularly related to text processing based upon the use of word occurrence in a specified part of a predetermined text database.

### BACKGROUND OF THE INVENTION

In order to search certain sentences that a user needs from a text database containing a plurality of sentences, a common method is that the user inputs a keyword containing one or multiple words and a sentence corresponding to the keyword is selected. However, depending upon the user purposes, there are certain situations where not a word but a sentence is more suitable for a search request. If the search request contains only two or three short sentences, unnecessary words such as helping words are removed from the search request and the remaining words are used as search words or keywords. In the above described situation, the selected keyword allows the search at a sufficiently precise level to find a sentence that the user seeks.

For example, Japanese Patent Publication 2001-142897 discloses a method of extracting essential words from the search request input by removing unnecessary words based upon a predetermined unnecessary word list. The unnecessary word list generally includes grammatical articles, propositions, conjunctions as well as nouns. The remaining words after removing the unnecessary words are weighted and connected by a search conditional word such as AND or OR. Furthermore, the search conditions include a number of consecutive words that separate the selected keywords in the search. When the number of remaining words is more than two, the remaining words are placed into pairs. Another search condition is based upon the occurrence of the remaining word pairs in a predetermined text database. If the occurrence of a word pair exceeds a predetermined threshold, the word pair is used as a search keyword.

Despite the above prior art, when a long search inquiry such as an entire text is used, the above and other prior art techniques result in a large number of search words or keywords. Because of the numerous search words, not only it would take a search an inordinate amount of time to complete, but also the retrieval effectiveness often becomes less accurate. For example, adverbial nouns such as “last year” and “year before last” are not useful for the search in almost all situations. However, it is difficult to include every word to define as the unnecessary word without any omission.

Furthermore, although the style, vocabulary and content of a short keyword input do not relatively affect the search, the style, vocabulary and content of a long search request substantially affect the search. In particular, when a search request grossly differs from the text to be searched in style, vocabulary and content, the effect is substantial. For example, if a newspaper article is a search request while a patent publication is a text to be searched, the retrieval effectiveness is undesirably degraded. In a detailed example, the word, “sale” is often seen in the newspaper but is rarely seen in the patent publication. In general, a word is considered important when its occurrence has a less frequency in the text database to be searched. For this reason, in the same example, the word, “sale” is unfortunately considered to be an important search word.

In view of the above prior art problems, it is desired to select useful or meaningful words for a text search even when a long text is inputted as a search request. It is also desired to select useful or meaningful words for a text search even when a search request grossly differs from the text to be searched in style, vocabulary and content.

### SUMMARY OF THE INVENTION

In order to solve the above and other problems, according to a first aspect of the current invention, a method of processing text data, including the steps of: inputting text data; parsing the text data into word candidates; removing predetermined words from the word candidates; specifying an area of a predetermined text database; and determining a specific area occurrence value of each of the word candidates in the specified area in the predetermined text database.

According to a second aspect of the current invention, a method of processing text data, including the steps of: inputting text data; parsing the text data into word candidates; removing predetermined words from the word candidates; determining a first text database occurrence value of the word candidates in a first text database; determining a second text database occurrence value of the word candidates in a second text database; determining a database occurrence value based upon the first text database occurrence value and the second text database occurrence value in a predetermined manner; selecting search words from the word candidates based upon in part the database occurrence value; and extracting sentences from a predetermined text database based upon the selected search words.

According to a third aspect of the current invention, a computer program for processing text data, performing the tasks of: inputting text data; parsing the text data into word candidates; removing predetermined words from the word candidates; specifying an area of a predetermined text database; and determining a specific area occurrence value of each of the word candidates in the specified area in the predetermined text database in a predetermined manner.

According to a fourth aspect of the current invention, a computer program for processing text data, performing the tasks of: inputting text data; parsing the text data into word candidates; removing predetermined words from the word candidates; determining a first text database occurrence value of the word candidates in a first text database; determining a second text database occurrence value of the word candidates in a second text database; determining a database occurrence value based upon the first text database occurrence value and the second text database occurrence value in a predetermined manner; selecting search words from the word candidates based upon in part the database occurrence value; and extracting sentences from the predetermined text database based upon the selected search words.

According to a fifth aspect of the current invention, an apparatus for processing text data, including: an input unit for inputting text data; a search word selection unit connected to the input unit for parsing the text data into word candidates, the search word selection unit removing predetermined words from the word candidates; an area specification unit for specifying an area of a predetermined text database; and a specific area occurrence determination unit connected to the search word selection unit and the area specification unit for determining a specific area occurrence value of each of the word candidates in the specified area in the predetermined text database.

According to a sixth aspect of the current invention, an apparatus for processing text data, including: an input unit for inputting text data; a search word selection unit connected to the input unit for parsing the text data into word candidates, the search word selection unit removing predetermined words from the word candidates; a database occurrence determination unit connected to the search word selection unit for determining a first text database occurrence value of the word candidates in a first text database and a second text database occurrence value of the word candidates in a second text database, the database occurrence determination unit further determining a database occurrence value based upon the first text database occurrence value and the second text database occurrence value in a predetermined manner, wherein the search word selection unit selects search words from the word candidates based upon in part the database occurrence value; and a text selection unit connected to the search word selection unit for extracting sentences from the predetermined text database based upon the selected search words.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating electrical connections among components for one preferred embodiment of the text search apparatus according to the current invention.

FIG. 2 is a diagram illustrating a document search apparatus that is implemented in a server computer according to the current invention.

FIG. 3 is a functional diagram illustrating modules of the text search software programs in the text search apparatus according to the current invention.

FIG. 4 is a flow chart illustrating steps or acts involved in a preferred process that is performed by the text search apparatus according to the current invention.

FIG. 5 is a block diagram illustrating a second preferred embodiment of the text search apparatus according to the current invention.

FIG. 6 is a flow chart illustrating steps or acts involved in a second preferred process that is performed by the second preferred embodiment of the text search apparatus according to the current invention.

FIG. 7 is a block diagram illustrating a third preferred embodiment of a keyword selection apparatus according to the current invention.

FIG. 8 is a flow chart illustrating steps or acts involved in a third preferred process that is performed by the third preferred embodiment of the keyword selection apparatus according to the current invention.

FIG. 9 is a block diagram illustrating a fourth preferred embodiment of a text summary apparatus according to the current invention.

FIG. 10 is a flow chart illustrating steps or acts involved in a fourth preferred process that is performed by the fourth preferred embodiment of the text summary apparatus according to the current invention.

FIG. 11 is a block diagram illustrating a fifth preferred embodiment of a text classification apparatus according to the current invention.

FIG. 12 is a flow chart illustrating steps or acts involved in a fifth preferred process that is performed by the fifth preferred embodiment of the text classification apparatus according to the current invention.

### DETAILED DESCRIPTION OF THE PREFERRED EMBODIMENT(S)

Based upon incorporation by external reference, the current application incorporates all disclosures in the corresponding foreign priority document from which the current application claims priority.

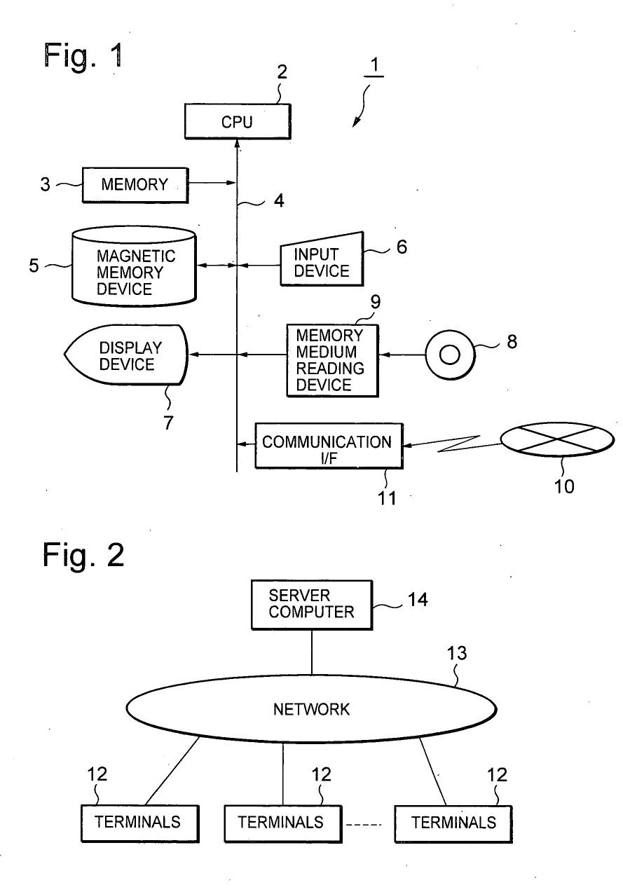

Referring now to the drawings, wherein like reference numerals designate corresponding structures throughout the views, and referring in particular to FIG. 1, a diagram illustrates electrical connections among components for one preferred embodiment of the text search apparatus according to the current invention. The text search apparatus 1 includes a computer such as a personal computer (PC) having a central processing unit (CPU) 2 for centrally controlling various components of the text search apparatus 1, a memory unit 3 having various read only memory (ROM) and random access memory (RAM) and a bus 4 for connecting the above described components. The bus 4 is connected via a predetermined interface to a magnetic memory device 5, an input device 6 such as a mouse and a keyboard, a display device 7 such as a liquid crystal display (LCD) and a cathode ray tube (CRT), a memory medium reading device 9 for reading a memory medium 8 such as an optical disk and a communication interface 11 for communicating with a network 10 such as the Internet. Furthermore, the memory media 8 include various media having magneto-optical disks, floppy disks and optical disks such as compact disks (CD) and digital versatile or video disks (DVD). The memory medium reading device 9 includes an optical disk drive, a magneto optical disk drive and a floppy disk drive.

Still referring to FIG. 1, the magnetic memory device 5 stores an information conversion program or a text search program that has implemented the software program or the method according to the current invention. The information conversion program is installed in the magnetic memory device 5 from the memory media 8 via the memory medium reading device 9 or downloaded from the network 10 such as the Internet. The above described installation enables the text search apparatus 1 to be operable. The text search program is a part of a certain application program. Alternatively, the text search program operates on a predetermined operating system (OS).

Now referring to FIG. 2, a diagram illustrates a document search apparatus 1 that is implemented in a server computer 14 according to the current invention. The server computer is connected to terminals 12 via a network 13 so that the server computer 14 is controlled from the terminals 12. The terminals 12 are alternatively implemented as information processing devices such as personal computers, personal digital assistants (PDA) and portable telephones. The network 13 is wireless or cable. For example, the network 13 includes local area network (LAN), wide area network (WAN), the Internet, analog telephone network, digital telephone network such as Integrated Services Digital Network (ISDN), personal handy phone system (PHS) network, cellular phone network and satellite communication network.

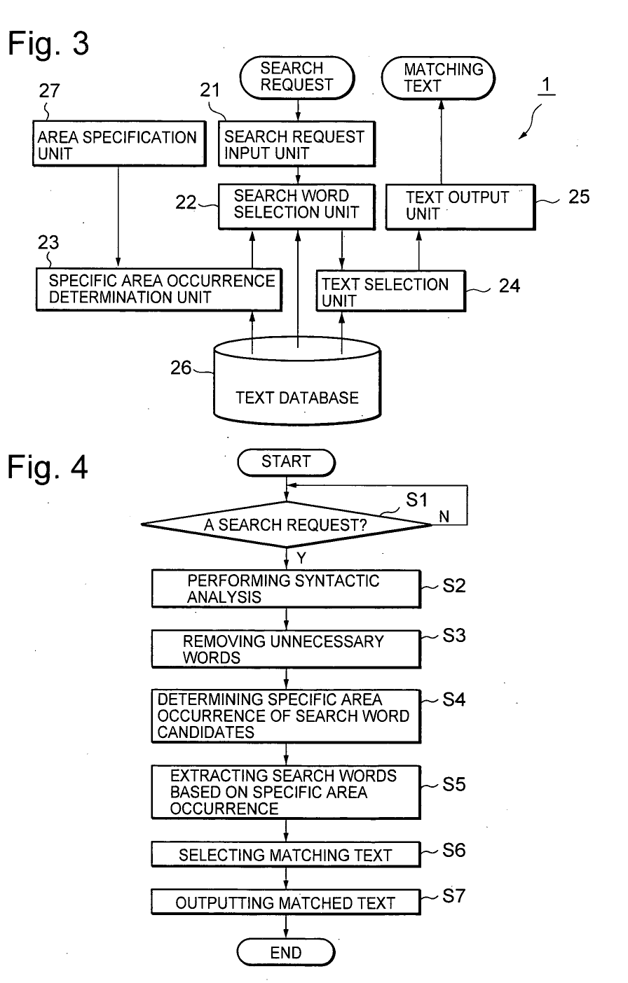

Now referring to FIG. 3, a functional diagram illustrates modules of the text search software programs in the text search apparatus 1 according to the current invention. The text search apparatus 1 includes a search request input unit 21 for receiving text as a search request input, a search word selection unit 22 for extracting search word candidates and calculating corresponding significance values for search words, a specific area occurrence determination unit 23 for determining the specific area occurrence value of the search word candidates in a specified area or portion of the text, a text selection unit 24, a text output unit 25, a text database 26 and an area specification unit 27. The text database 26 is implemented by the magnetic memory unit 5 or alternatively outside of the text search apparatus 1.

FIG. 4 is a flow chart illustrating steps or acts involved in a preferred process that is performed by the text search apparatus 1 according to the current invention. The following steps or acts are described with respect to the components or units of the text search apparatus 1 as illustrated in FIGS. 1 through 3. In a step S1, a user inputs text or sentences as a search request into the search request input unit 21 via an input device such as a keyboard. The step S1 implements an input means. In one example, a search request is a sentence, “Yesterday, the company, “A” announced a new printer AcmePrinter” that is quoted from a newspaper article. After the above input following the step 1Y, the search word selection unit 22 performs a morphological analysis and parses the input text according to a predetermined word dictionary in a step 2. In a step 3, if the extracted words are listed in a predetermined unnecessary word list, these unnecessary words are omitted and the remaining words are defined as the search word candidates. Based upon the above search request example, since “a” and “the” are unnecessary words, these words are removed. As a result, “company, A,” “yesterday” “new,” “printer,” “AcmePrinter” and “announced” remain as the search words. The above steps 2 and 3 implement a word extraction means.

In the next step, the search significance value for each of the search word candidates is determined. One example of the determination is based upon the following equation (1):

The significance value=predetermined weight of word (1)

The word weight is generally determined by log (a total number of documents/a number of documents in which the word candidate occurs). That is, the words are considered significant if they appear relatively less frequently in the text that is stored in the text database 26. However, in the above text search apparatus 1, the specific area occurrence determination unit 23 determines the specific area occurrence value of each of the search word candidates in a specified portion of the target text that is stored in the text database 26. For example, the specified portion includes a header and a summary, and the occurrence of a search word in a specified important portion is factored into the significance value.

Specific examples are provided below for the operation of the specific area occurrence determination unit 23. In a specific example of specifying the header in the text, the specific area occurrence determination unit 23 determines the specific portion or area occurrence value as follows:

$$\begin{matrix}\begin{matrix}the specific area \\ occurrence value\end{matrix} = a number of documents including \\ the search word in the header / \\ a number of documents including \\ the search word in the entire text\end{matrix} \qquad ( 2 )$$

In another example of specifying the summary in the text, the specific area occurrence determination unit 23 determines the specific area occurrence value as follows:

$$\begin{matrix}\begin{matrix}the specific area \\ occurrence value\end{matrix} = a number of documents including \\ the search word in the summary / \\ a number of documents including \\ the search word in the entire text\end{matrix} \qquad ( 3 )$$

In yet another example of specifying both the header and the summary in the text, the specific area occurrence determination unit 23 determines the specific area occurrence value as follows:

$$\begin{matrix}\begin{matrix}the specific area \\ occurrence value\end{matrix} = a number of documents including the \\ search word in the summary or the header / \\ a number of documents including \\ the search word in the entire text\end{matrix} \qquad ( 4 )$$

Alternatively, the above equations (2) and (3) are combined to have the following:

$$\begin{matrix}\begin{matrix}the specific area \\ occurrence value\end{matrix} = ( a number of documents including \\ the search word in the header / \\ a number of documents including \\ the search word in the entire text ) + \\ ( a number of documents including \\ the search word in the summary / \\ a number of documents including \\ the search word in the entire text )\end{matrix} \qquad ( 5 )$$

By determining the specific area occurrence value using any of the above described means, a word that is frequently used in the specified portion is identified. Some of the assumption for the above determination include that each of the digitized text in the text database 26 owns data indicative of the partial range such as a header and a summary or owns the occurrence data of certain words in the predetermined portions such as the header and the summary.

After the step 4 where the specific area occurrence determination unit 23 determines the specific area occurrence value for each of the search word candidates, the search word selection unit 22 determines the significance value of the search candidates based upon the specific area occurrence value and extracts the search words in a step S5. The step 4 implements an occurrence calculation means while the step 5 implements a search word selection means. Similarly, the steps 1 through 4 thus implement a word occurrence calculation means. That is, from the equation (1),

the search word significance value=the word weight×the specific area occurrence value (6)

In the alternative, if the search request text is long,

$$\begin{matrix}\begin{matrix}the search word \\ significance value\end{matrix} = the word weight \times the specific area \\ occurrence value \times the occurrence \\ within the search request text\end{matrix} \qquad ( 7 )$$

As described above, using the specific area occurrence value, the words are prioritized according to the occurrence frequency in a specified important section of the text. With respect to this point, it will be further described using the above exemplary text. The previous example is that “Yesterday, Company, “A” announced a new printer AcmePrinter.” The search word candidates are “Company A,” “yesterday,” “new,” “printer,” “AcmePrinter” and “announced.” The following table shows the text occurrence value, the header occurrence value and the summary occurrence value for each word of the search word candidates. The text occurrence value indicates a number of documents including the search word candidate in the sets of text that are registered in the text database 26. The header occurrence value indicates a number of documents including the search word candidate in the header portion of the registered text. The summary occurrence value indicates a number of documents including the search word candidate in the summary portion of the registered text.

TABLE 1

| | Header | Summary | Text |
|---|---|---|---|
| | Occurrence | Occurrence | Occurrence |
| words | Value | Value | Value |
| Company A | 22 | 22 | 30 |
| yesterday | 0 | 10 | 16 |
| new | 2 | 8 | 24 |
| AcmePrinter | 8 | 8 | 12 |
| announced | 20 | 26 | 32 |

In the above example, if the equation (1) is applied, the significance value of the word, “yesterday” is relatively high. On the other hand, if the equation (6) is used to determine the significance value based upon the specific area occurrence value, the significance value is much lower.

After the significance value is determined for each of the search word candidates, in a step 5, the search word selection unit 22 prioritizes the search word candidates based according to the high significance values. For example, the search word selection unit 22 selects top ten of the prioritized search word candidates. The text selection unit 24 uses the search words that the search word selection unit 22 has selected to search matching text in the text database 26 in a step S6. The step 6 implements a text selection means. The text output unit 25 receives the matching text from the text selection unit 24 and outputs it as a search result in a step S7. Furthermore, the area specification unit 27 receives a selection input from a user, and the selection input indicates a type of a position or an area in text. The type includes a header and a summary that is used in determining the specific area occurrence value by the specific area occurrence determination unit 23. In response to the selection input, the specific area occurrence determination unit 23 determines the specific area occurrence value based upon one of the above described equations (1) through (5).

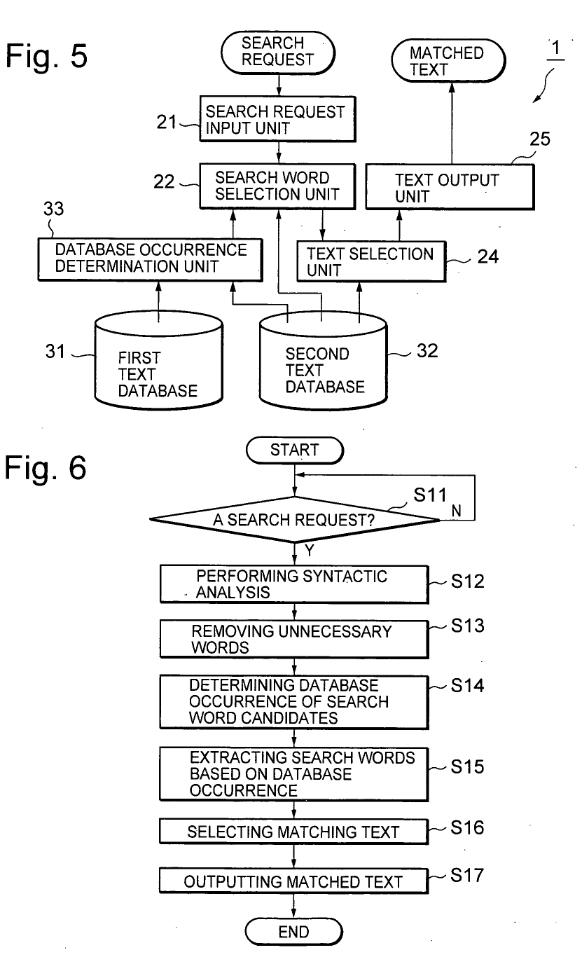

Now referring to FIG. 5, a block diagram illustrates a second preferred embodiment of the text search apparatus 1 according to the current invention. The text search apparatus 1 includes substantially identical components or units as indicated by the same reference numerals, and these components have been already described with respect to the first preferred embodiment in FIGS. 1 and 2. These substantially identical units in the second preferred embodiment will not be described with respect to FIG. 5. The difference between the first and second preferred embodiments includes a first text database 31 for storing a first text database, a second text database 32 for storing a second text database and a database occurrence determination unit 33 in lieu of the specific area occurrence determination unit 23. The database occurrence determination unit 33 determines a database occurrence value. The first text database 31 and the second text database 32 are implemented by the magnetic memory device 5 inside the text search device 1 or alternatively by an external device outside the text search device 1. The second text database 32 corresponds to the above described text database 26 and stores text to be searched. The first text database 31 is a text database having the substantially similar style, vocabulary and content as the search request. For example, the second text database 32 stores patent publications while the first text database 31 stores newspaper articles.

Referring to FIG. 6, a flow chart illustrates steps or acts involved in a second preferred process that is performed by the second preferred embodiment of the text search apparatus 1 according to the current invention. The following steps or acts are described with respect to the components or units of the text search apparatus 1 as illustrated in FIG. 5. Steps S11 through S13 are substantially identical to steps 1 through 3 of FIG. 4. The step S11 implements an input means while the steps S12 and S13 implement a word extraction means. The same example as previously used is assumed to be inputted as follows: “Yesterday, the company, “A” announced a new printer AcmePrinter.” The search word candidates are “Company A,” “yesterday,” “new,” “printer,” “AcmePrinter” and “announced.” As also previously applied, the equation (1) is generally used to determine the significance value of the search word candidates. If the number of text occurrences of a certain search word candidate is small in the second text database 32, the corresponding word candidate is regarded as a useful search word. However, in the text search apparatus 1, the database occurrence determination unit 33 takes into account a difference in the occurrence value between the first text database 31 and the second text database 32 in determining the significance value. As described above, the first text database 31 contains text as the search request substantially similar in style, vocabulary and content.

In a step S14, a database occurrence value is calculated. The step S14 implements an occurrence calculation means while the steps S11 through S14 implement a word occurrence value calculation means. For example, the database occurrence determination unit 33 performs the following calculation in order to obtain the database occurrence value.

$$\begin{matrix}\begin{matrix}The database \\ occurrence value\end{matrix} = Second text database occurrence value / \\ Total number of documents in the \\ second text database - First text database \\ occurrence value / Total number of \\ documents in the first text database\end{matrix} \qquad ( 8 )$$

where the database occurrence value is 0 if it is negative. Alternatively, the database occurrence determination unit 33 performs the following calculation in order to obtain the database occurrence value.

$$\begin{matrix}\begin{matrix}The database \\ occurrence value\end{matrix} = ( Second text database occurrence value / \\ Total number of documents in the \\ second text database ) / ( First text \\ database occurrence value / Total number \\ of documents in the first text database )\end{matrix} \qquad ( 9 )$$

where the database occurrence value is 1 if it is less than 1. As described above, by using the first word occurrence value in the first text database 31 and the second word occurrence value in the second text database 32, the database occurrence value is determined so that a search word is not likely selected from words that are used frequently in the first text database 31 but are not frequently used in the second text database 32. The search word selection unit 22 determines the significance value of the words based upon the database occurrence value from the database occurrence determination unit 33 in a step S15. That is, from the equation (1),

The significance value=Word Weight×Database Occurrence Value (10)

In this regard, it will be further described using the above exemplary search request: “Yesterday, the company, “A” announced a new printer AcmePrinter.” The search word candidates are “Company A,” “yesterday,” “new,” “printer,” “AcmePrinter” and “announced.” The following exemplary table shows that “Sentence Occurrences in First Text Database” indicative of a number of documents including the text stored in the first text database 31 and “Sentence Occurrences in Second Text Database” indicative of a number of documents including the text stored in the second text database 32.

TABLE 2

| | Sentence Occurrences | Sentence Occurrences in |
|---|---|---|
| Words | in First Text Database | Second Text Database |
| Company A | 30 | 3 |
| Yesterday | 16 | 0 |
| New | 24 | 18 |
| Printer | 12 | 10 |
| AcmePrinter | 6 | 0 |
| announced | 32 | 5 |

In the above example, when the significance value is determined based upon the Equation (1), the words such as Company A or announced have a high significance value. On the other hand, when the Equation (10) is applied, the above words have a low significance value.

In a step S15, after the significance value is determined for each search word candidate in the above described manner, the search word selection unit 22 prioritizes the search word candidates according to the significance value and selects a predetermined number of top candidates such as top ten candidates as search words. The step S15 implements a text selection means. Steps S16 and S17 are substantially the same as the steps S6 and S7 of FIG. 4. The steps S16 and S17 will not be further described here.

Furthermore, in the above example, the search request and the text to be searched are different in their nature. That is, the first and second text database 31 and 32 respectively store text from newspaper and patent publication. Even if the text has the same type, the text search apparatus 1 according to the current invention is useful when a search request and the text to be searched belong to a different field. For example, the patent publications belong to a different international patent classification (IPC). Another example is that a search request and text to be searched are authored by a different person.

In an alternative embodiment, the first preferred embodiment and the second preferred embodiment are combined. That is, to get the word occurrence, the specific area occurrence determination unit 23 and the database occurrence determination unit 33 are both used or combined.

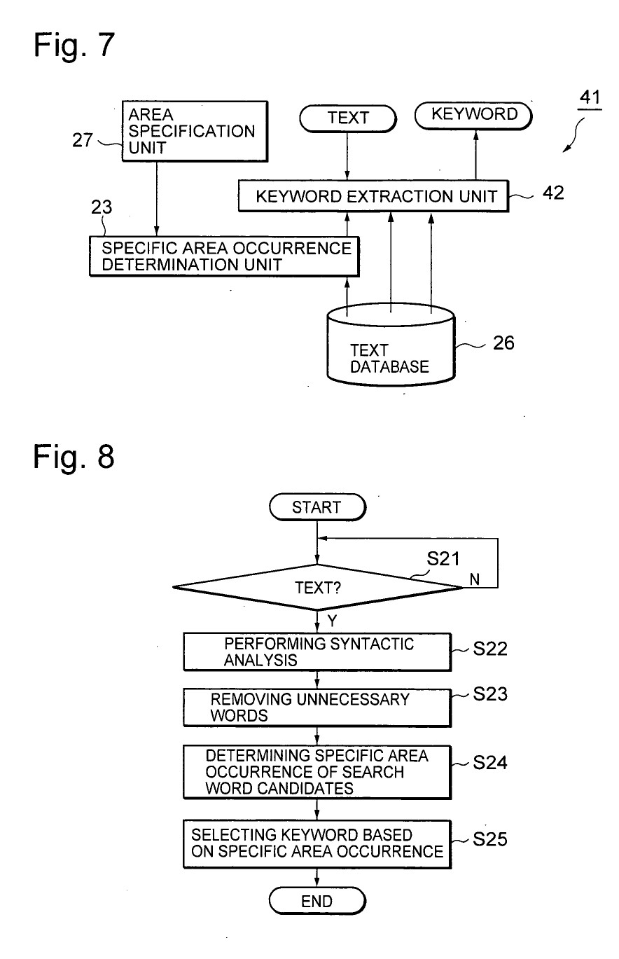

Now referring to FIG. 7, a block diagram illustrates a third preferred embodiment of a keyword selection apparatus 41 according to the current invention. The keyword selection apparatus 41 includes substantially identical components or units as indicated by the same reference numerals, and these components have been already described with respect to the first preferred embodiment in FIGS. 1 and 2. These substantially identical units in the third preferred embodiment will not be described with respect to FIG. 7. The keyword selection apparatus 41 further includes a keyword extraction unit 42, the text database 26, an area specification unit 27 and the specific area occurrence determination unit 23. The keyword selection apparatus 41 executes a keyword extraction program that has been installed from the memory medium 8 or the download from the network 10 as illustrated in the hardware component of FIG. 1. Using the text database 26 substantially identical as in the first preferred embodiment, the process by the keyword extraction program implements the specific area occurrence determination unit 23, the keyword extraction unit 42 and the area specification unit 27 that have the substantially identical functions of the first preferred embodiment.

Referring to FIG. 8, a flow chart illustrates steps or acts involved in a third preferred process that is performed by the third preferred embodiment of the keyword selection apparatus 41 according to the current invention. The following steps or acts are described with respect to the components or units of the keyword selection apparatus 41 as illustrated in FIG. 7. In a step S21, it is determined whether or not text has been inputted to the keyword extraction unit 42. If the text has not been inputted, the third preferred process waits for the text input. If the text has been inputted, the third preferred process proceeds to steps S22 and S23, where substantially identical tasks are performed as the above described step S2 and S3. From these steps, words are extracted as keyword candidates. The step S21 implements an input means while the steps S22 and S23 implement a word extraction means. In a step S24, the specific area occurrence determination unit 23 determines the specific area occurrence value of each keyword candidates as the first preferred embodiment. The step S24 implements an occurrence calculation means. Similarly, the steps S21 through S24 implement a word occurrence calculation device. The keyword extraction unit 42 determines the significance value of the word based upon the specific area occurrence value obtained in the specific area occurrence determination unit 23 as the first preferred embodiment. The keyword extraction unit 42 prioritizes the keyword candidates according to the significance value and selects a predetermined number of top candidates such as top ten candidates as keywords in a step S25. The step S25 implements a keyword selection means. As described above, keywords reflecting the characteristics of each text are appropriately extracted according to the current invention.

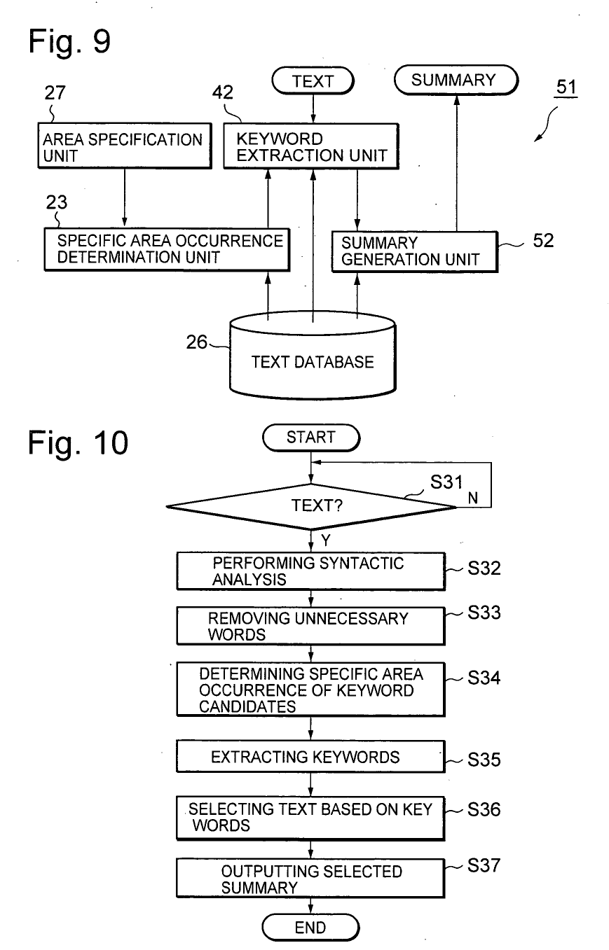

Now referring to FIG. 9, a block diagram illustrates a fourth preferred embodiment of a text summary apparatus 51 according to the current invention. The text summary apparatus 51 includes substantially identical components or units as indicated by the same reference numerals, and these components have been already described with respect to the first preferred embodiment in FIGS. 1 and 2. These substantially identical units in the fourth preferred embodiment will not be described with respect to FIG. 9. The text summary apparatus 51 further includes a keyword extraction unit 42, the text database 26, an area specification unit 27, a summary generation unit 52, and the specific area occurrence determination unit 23. The text summary apparatus 51 executes a summary generation program that has been installed from the memory medium 8 or the download from the network 10 as illustrated in the hardware component of FIG. 1. Using the text database 26 substantially identical as in the third preferred embodiment, the process by the summary generation program implements the specific area occurrence determination unit 23 and the keyword extraction unit 42 that have the substantially identical functions of the third preferred embodiment. The difference from the third preferred embodiment is that the summary generation program additionally implements the functions of the summary generation unit 52 that will be further described below.

Referring to FIG. 10, a flow chart illustrates steps or acts involved in a fourth preferred process that is performed by the fourth preferred embodiment of the text summary apparatus 51 according to the current invention. The following steps or acts are described with respect to the components or units of the text summary apparatus 51 as illustrated in FIG. 9. Steps 31 through 34 are substantially identical to the steps S21 through S24 of the third preferred process as described with respect to FIG. 8. The step S31 implements an input means, and the steps S32 and S33 implement a word extraction means. The step S34 implements an occurrence calculation means.

Furthermore, the above steps 31 through 34 collectively implement a word occurrence calculation device. As performed by the third preferred process, the keyword extraction unit 42 extracts a keyword in a step S35 of the fourth preferred process. The step 35 implements a keyword extraction means. As described above, keywords reflecting the characteristics of each text are appropriately extracted according to the current invention. From the text inputted in the step 31, the summary generation unit 52 extracts sentences that contain a predetermined number of keywords in step S36. In a step 37, the extracted sentences are outputted as a summary. For example, top ten sentences are outputted according to the number of contained keywords. The step S36 implements a summary generation means. As described above, a summary is appropriately generated.

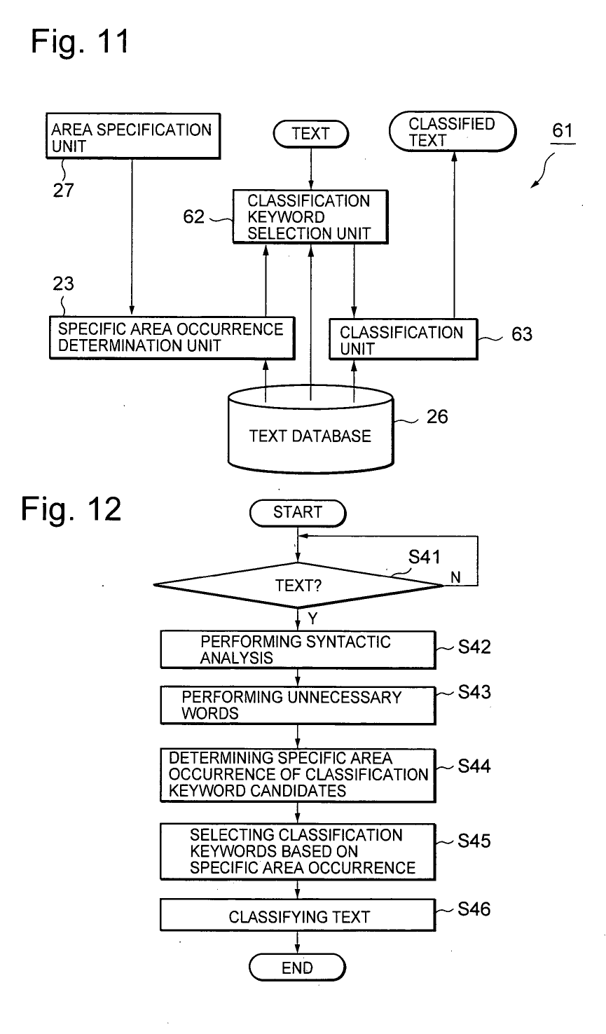

Now referring to FIG. 11, a block diagram illustrates a fifth preferred embodiment of a text classification apparatus 61 according to the current invention. The text classification apparatus 61 includes substantially identical components or units as indicated by the same reference numerals, and these components have been already described with respect to the first preferred embodiment in FIGS. 1 and 2. These substantially identical units in the fifth preferred embodiment will not be described with respect to FIG. 11. The text classification apparatus 61 further includes a classification keyword selection unit 62, the text database 26, an area specification unit 27, and a classification unit 63. The text classification apparatus 61 executes a text classification program that has been installed from the memory medium 8 or the download from the network 10 as illustrated in the hardware component of FIG. 1. Using the text database 26 substantially identical as in the first preferred embodiment, the process by the text classification program implements the specific area occurrence determination unit 23 and the area specification unit 27 that have the substantially identical functions of the first preferred embodiment. The difference from the third preferred embodiment is that the text classification-program additionally implements the functions of the classification keyword selection unit 62 and the classification unit 63. Furthermore, the classification keyword selection unit 62 and the classification unit 63 will be later further described.

Referring to FIG. 12, a flow chart illustrates steps or acts involved in a fifth preferred process that is performed by the fifth preferred embodiment of the text classification apparatus 61 according to the current invention. The following steps or acts are described with respect to the components or units of the text classification apparatus 61 as illustrated in FIG. 11. When it is determined that text is inputted to the classification keyword selection unit 62 in a step S41, steps S42 and S43 perform tasks that are substantially identical to the above described steps S2 and S3 of FIG. 4. In this manner, the extracted words become classification keyword candidates. The step S41 implements an input means, and the steps S42 and S43 implement a word extraction means. In a step S44, the specific area occurrence determination unit 23 determines the specific area occurrence value of each classification keyword candidates. The step S44 implements an occurrence calculation means. Furthermore, the functions in the steps S41 through S44 implement a word occurrence calculation means. The classification keyword selection unit 62 determines the significance value of the words based upon the calculated specific area occurrence as the first preferred embodiment does and prioritizes the classification keywords according to the significance values. For example, the classification keyword selection unit 62 extracts top ten classification keywords as classification keywords in a step S45. The step S45 implements a classification keyword extraction means. In the above described manner, the classification unit 63 classifies the text based upon the classification keyword selected for each text in a step S46. The step S46 implements a classification means. For example, a vector is generated for each classification keyword using a significance value as an entry, and after calculating the dot product and the distance between the vectors, the documents are classified in a common category if the corresponding vectors have a predetermined close distance. Since some of the above technique are known as prior art, the details will not be further described here. The classified text is thus obtained.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of processing text data, comprising the steps of:
inputting text data;
parsing the text data into word candidates;
removing predetermined words from the word candidates;
specifying an area of a predetermined text database; and
determining a specific area occurrence value of each of the word candidates in the specified area in the predetermined text database.

2. The method of processing text data according to claim 1 wherein the specified area is a header area.

3. The method of processing text data according to claim 2 wherein the specific area occurrence value is determined according to a following equation:
$$\begin{matrix}\begin{matrix}the specific area \\ occurrence value\end{matrix} = a number of documents including the word \\ candidate in the header area / a number of \\ documents including the word candidate in \\ an entire portion of the predetermined \\ text database .\end{matrix}$$

4. The method of processing text data according to claim 1 wherein the specified area is a summary area.

5. The method of processing text data according to claim 4 wherein the specific area occurrence value is determined according to a following equation:
$$\begin{matrix}\begin{matrix}the specific area \\ occurrence value\end{matrix} = a number of documents including the word \\ candidate in the summary area / a number of \\ documents including the word candidate in \\ an entire portion of the predetermined \\ text database .\end{matrix}$$

6. The method of processing text data according to claim 1 wherein the specified area is a combination of a header area and a summary area.

7. The method of processing text data according to claim 6 wherein the specific area occurrence value is determined according to a following equation:
$$\begin{matrix}\begin{matrix}the specific area \\ occurrence value\end{matrix} = a number of documents including the word \\ candidate in either one of the summary area \\ and the header area / a number of documents \\ including the word candidate in an entire \\ portion of the predetermined text database .\end{matrix}$$

8. The method of processing text data according to claim 6 wherein the specific area occurrence value is determined according to a following equation:
$$\begin{matrix}\begin{matrix}the specific area \\ occurrence value\end{matrix} = ( a number of documents including the word \\ candidate in the header area / a number of \\ documents including the word candidate in \\ an entire portion of the predetermined text \\ database ) + ( a number of documents including \\ the word candidate in the summary area / a \\ number of documents including the word \\ candidate in an entire portion of the \\ predetermined text database )\end{matrix}$$

9. The method of processing text data according to claim 1 further comprising an additional step of determining a search word significance value based upon a following equation:
$$\begin{matrix}\begin{matrix}the search word \\ significance value\end{matrix} = a corresponding predetermined word \\ weight \times the specific area occurrence value ,\end{matrix}$$
wherein the corresponding predetermined word weight is log (a total number of documents/the number of documents in which the word candidate occurs).

10. The method of processing text data according to claim 1 further comprising an additional step of:
determining a search word significance value based upon a following equation:
$$\begin{matrix}\begin{matrix}the search word \\ significance value\end{matrix} = a corresponding predetermined word \\ weight \times the specific area occurrence value \times \\ a number of occurrences of the word \\ candidate within the text data .\end{matrix}$$

11. The method of processing text data according to claim 1 further comprising additional steps of:
selecting search words from the word candidates based upon the specific area occurrence value; and
extracting sentences from the predetermined text database based upon the selected search words.

12. The method of processing text data according to claim 1 further comprising an additional step of selecting keywords from the word candidates based upon the specific area occurrence value.

13. The method of processing text data according to claim 1 further comprising additional steps of:
selecting keywords from the word candidates based upon the specific area occurrence value; and
generating a summary from the predetermined text database based upon the selected keywords.

14. The method of processing text data according to claim 1 further comprising additional steps of:
selecting classification keywords from the word candidates based upon the specific area occurrence value; and
classifying the predetermined text database based upon the selected classification keywords.

15. The method of processing text data according to claim 1 further comprising additional steps of:
determining a first text database occurrence value of the word candidates in a first text database;
determining a second text database occurrence value of the word candidates in a second text database;
determining a database occurrence value based upon the first text database occurrence value and the second text database occurrence value in a predetermined manner;
selecting search words from the word candidates based upon in part the database occurrence value; and
extracting sentences from a predetermined text database based upon the selected search words.

16. The method of processing text data according to claim 15 wherein the database occurrence value is determined by a following equation:
$$\begin{matrix}\begin{matrix}the database \\ occurrence value\end{matrix} = ( the second text database occurrence value / \\ a total number of documents in the second \\ text database ) - ( the first text database \\ occurrence value / a total number of \\ documents in the first text database ) .\end{matrix}$$

17. The method of processing text data according to claim 15 wherein the database occurrence value is determined by a following equation:
$$\begin{matrix}\begin{matrix}the database \\ occurrence value\end{matrix} = ( the second text database occurrence value / \\ a total number of documents in the second \\ text database ) / ( the first text database \\ occurrence value / a total number of \\ documents in the first text database ) .\end{matrix}$$

18. The method of processing text data according to claim 15 further comprising an additional step of determining a search word significance value based upon a following equation:
$$\begin{matrix}\begin{matrix}the search word \\ significance value\end{matrix} = the corresponding predetermined word \\ weight \times the database occurrence value ,\end{matrix}$$
wherein the corresponding predetermined word weight is log (a total number of documents/the number of documents in which the word candidate occurs).

19. A method of processing text data, comprising the steps of:
inputting text data;
parsing the text data into word candidates;
removing predetermined words from the word candidates;
determining a first text database occurrence value of the word candidates in a first text database;
determining a second text database occurrence value of the word candidates in a second text database;
determining a database occurrence value based upon the first text database occurrence value and the second text database occurrence value in a predetermined manner;
selecting search words from the word candidates based upon in part the database occurrence value; and
extracting sentences from a predetermined text database based upon the selected search words.

20. The method of processing text data according to claim 19 wherein the database occurrence value is determined by a following equation:
$$\begin{matrix}\begin{matrix}the database \\ occurrence value\end{matrix} = ( the second text database occurrence value / \\ a total number of documents in the second \\ text database ) - ( the first text database \\ occurrence value / a total number of \\ documents in the first text database ) .\end{matrix}$$

21. The method of processing text data according to claim 19 wherein the database occurrence value is determined by a following equation:
$$\begin{matrix}\begin{matrix}the database \\ occurrence value\end{matrix} = ( the second text database occurrence value / \\ a total number of documents in the second \\ text database ) / ( the first text database \\ occurrence value / a total number of \\ documents in the first text database ) .\end{matrix}$$

22. The method of processing text data according to claim 19 further comprising an additional step of determining a search word significance value based upon a following equation:
$$\begin{matrix}\begin{matrix}the search word \\ significance value\end{matrix} = the corresponding predetermined word \\ weight \times the database occurrence value ,\end{matrix}$$
wherein the corresponding predetermined word weight is log (a total number of documents/the number of documents in which the word candidate occurs).

23. A computer program for processing text data, performing the tasks of:
inputting text data;
parsing the text data into word candidates;
removing predetermined words from the word candidates;
specifying an area of a predetermined text database; and
determining a specific area occurrence value of each of the word candidates in the specified area in the predetermined text database in a predetermined manner.

24. The computer program for processing text data according to claim 23 wherein the specified area is a header area.

25. The computer program for processing text data according to claim 24 wherein the specific area occurrence value is determined according to a following equation:
$$\begin{matrix}\begin{matrix}the specific area \\ occurrence value\end{matrix} = a number of documents including the word \\ candidate in the header area / a number of \\ documents including the word candidate in \\ an entire portion of the predetermined \\ text database .\end{matrix}$$

26. The computer program for processing text data according to claim 23 wherein the specified area is a summary area.

27. The computer program for processing text data according to claim 26 wherein the specific area occurrence value is determined according to a following equation:
$$\begin{matrix}\begin{matrix}the specific area \\ occurrence value\end{matrix} = a number of documents including the word \\ candidate in the summary area / a number of \\ documents including the word candidate in \\ an entire portion of the predetermined \\ text database .\end{matrix}$$

28. The computer program for processing text data according to claim 23 wherein the specified area is a combination of a header area and a summary area.

29 The computer program for processing text data according to claim 28 wherein the specific area occurrence value is determined according to a following equation:
$$\begin{matrix}\begin{matrix}the specific area \\ occurrence value\end{matrix} = a number of documents including the word \\ candidate in either one of the summary area \\ and the header area / a number of documents \\ including the word candidate in an entire \\ portion of the predetermined text database .\end{matrix}$$

30. The computer program for processing text data according to claim 28 wherein the specific area occurrence value is determined according to a following equation:
$$\begin{matrix}\begin{matrix}the specific area \\ occurrence value\end{matrix} = ( a number of documents including the word \\ candidate in the header area / a number of \\ documents including the word candidate in \\ an entire portion of the predetermined text \\ database ) + ( a number of documents including \\ the word candidate in the summary area / a \\ number of documents including the word \\ candidate in an entire portion of the \\ predetermined text database ) .\end{matrix}$$

31. The computer program for processing text data according to claim 23 further comprising an additional task of determining a search word significance value based upon a following equation:
$$\begin{matrix}\begin{matrix}the search word \\ significance value\end{matrix} = a corresponding predetermined word \\ weight \times the specific area occurrence value ,\end{matrix}$$
wherein the corresponding predetermined word weight is log (a total number of documents/the number of documents in which the word candidate occurs).

32. The computer program for processing text data according to claim 23 further performing an additional task of determining a search word significance value based upon a following equation:
$$\begin{matrix}\begin{matrix}the search word \\ significance value\end{matrix} = a corresponding predetermined word \\ weight \times the specific area occurrence value \times \\ a number of occurrences of the word \\ candidate within the text data .\end{matrix}$$

33. The computer program for processing text data according to claim 23 further performing additional tasks of:
selecting search words from the word candidates based upon the specific area occurrence value; and
extracting sentences from the predetermined text database based upon the selected search words.

34. The computer program for processing text data according to claim 23 further performing an additional task of selecting keywords from the word candidates based upon the specific area occurrence value.

35. The computer program for processing text data according to claim 23 further performing additional tasks of:
selecting keywords from the word candidates based upon the specific area occurrence value; and
generating a summary from the predetermined text database based upon the selected keywords.

36. The computer program for processing text data according to claim 23 further performing additional tasks of:
selecting classification keywords from the word candidates based upon the specific area occurrence value; and
classifying the predetermined text database based upon the selected classification keywords.

37. The computer program for processing text data according to claim 23 further performing additional task of:
determining a first text database occurrence value of the word candidates in a first text database;
determining a second text database occurrence value of the word candidates in a second text database;
determining a database occurrence value based upon the first text database occurrence value and the second text database occurrence value in a predetermined manner;
selecting search words from the word candidates based upon in part the database occurrence value; and
extracting sentences from the predetermined text database based upon the selected search words.

38. The computer program for processing text data according to claim 37 wherein the database occurrence value is determined by a following equation:
$$\begin{matrix}\begin{matrix}the database \\ occurrence value\end{matrix} = ( the second text database occurrence value / \\ a total number of documents in the second \\ text database ) - ( the first text database \\ occurrence value / a total number of \\ documents in the first text database ) .\end{matrix}$$

39. The computer program for processing text data according to claim 37 wherein the database occurrence value is determined by a following equation:
$$\begin{matrix}\begin{matrix}the database \\ occurrence value\end{matrix} = ( the second text database occurrence value / \\ a total number of documents in the second \\ text database ) / ( the first text database \\ occurrence value / a total number of \\ documents in the first text database ) .\end{matrix}$$

40. The computer program for processing text data according to claim 37 further performing an additional task of determining a search word significance value based upon a following equation:
$$\begin{matrix}\begin{matrix}the search word \\ significance value\end{matrix} = the corresponding predetermined word \\ weight \times the database occurrence value ,\end{matrix}$$
wherein the corresponding predetermined word weight is log (a total number of documents/the number of documents in which the word candidate occurs).

41. A computer program for processing text data, performing the tasks of:
inputting text data;
parsing the text data into word candidates;
removing predetermined words from the word candidates;
determining a first text database occurrence value of the word candidates in a first text database;
determining a second text database occurrence value of the word candidates in a second text database;
determining a database occurrence value based upon the first text database occurrence value and the second text database occurrence value in a predetermined manner;
selecting search words from the word candidates based upon in part the database occurrence value; and
extracting sentences from the predetermined text database based upon the selected search words.

42. The computer program for processing text data according to claim 41 wherein the database occurrence value is determined by a following equation:
$$\begin{matrix}\begin{matrix}the database \\ occurrence value\end{matrix} = ( the second text database occurrence value / \\ a total number of documents in the second \\ text database ) - ( the first text database \\ occurrence value / a total number of \\ documents in the first text database ) .\end{matrix}$$

43. The computer program for processing text data according to claim 41 wherein the database occurrence value is determined by a following equation:
$$\begin{matrix}\begin{matrix}the database \\ occurrence value\end{matrix} = ( the second text database occurrence value / \\ a total number of documents in the second \\ text database ) / ( the first text database \\ occurrence value / a total number of \\ documents in the first text database ) .\end{matrix}$$

44. The computer program for processing text data according to claim 41 further comprising an additional step of determining a search word significance value based upon a following equation:
$$\begin{matrix}\begin{matrix}the search word \\ significance value\end{matrix} = the corresponding predetermined word \\ weight \times the database occurrence value ,\end{matrix}$$
wherein the corresponding predetermined word weight is log (a total number of documents/a number of documents including the word candidate in an entire portion of the predetermined text database).

45. A apparatus for processing text data, comprising:
an input unit for inputting text data;
a search word selection unit connected to said input unit for parsing the text data into word candidates, said search word selection unit removing predetermined words from the word candidates;
an area specification unit for specifying an area of a predetermined text database; and
a specific area occurrence determination unit connected to said search word selection unit and said area specification unit for determining a specific area occurrence value of each of the word candidates in the specified area in the predetermined text database.

46. The apparatus for processing text data according to claim 45 wherein the specified area is a header area.

47. The apparatus for processing text data according to claim 46 wherein said specific area occurrence determination unit determines the specific area occurrence value according to a following equation:
$$\begin{matrix}\begin{matrix}the specific area \\ occurrence value\end{matrix} = a number of documents including the word \\ candidate in the header area / a number of \\ documents including of the word candidate \\ in an entire portion of the predetermined \\ text database .\end{matrix}$$

48. The apparatus for processing text data according to claim 45 wherein the specified area is a summary area.

49. The apparatus for processing text data according to claim 48 wherein said specific area occurrence determination unit determines the specific area occurrence value according to a following equation:
$$\begin{matrix}\begin{matrix}the specific area \\ occurrence value\end{matrix} = a number of documents including the word \\ candidate in the summary area / a number of \\ documents including the word candidate in \\ an entire portion of the predetermined \\ text database .\end{matrix}$$

50. The apparatus for processing text data according to claim 45 wherein the specified area is a combination of a header area and a summary area.

51. The apparatus for processing text data according to claim 50 wherein said specific area occurrence determination unit determines the specific area occurrence value according to a following equation:
$$\begin{matrix}\begin{matrix}the specific area \\ occurrence value\end{matrix} = a number of documents including the word \\ candidate in either one of the summary area \\ and the header area / a number of documents \\ including the word candidate in an entire \\ portion of the predetermined text database .\end{matrix}$$

52. The apparatus for processing text data according to claim 50 wherein said specific area occurrence determination unit determines the specific area occurrence value according to a following equation:
$$\begin{matrix}\begin{matrix}the specific area \\ occurrence value\end{matrix} = ( a number of documents including the word \\ candidate in the header area / a number of \\ documents including the word candidate in \\ an entire portion of the predetermined text \\ database ) + ( a number of documents including \\ the word candidate in the summary area / a \\ number of documents including the word \\ candidate in an entire portion of the \\ predetermined text database ) .\end{matrix}$$

53. The apparatus for processing text data according to claim 45 wherein said search word selection unit further determines a search word significance value based upon a following equation:
$$\begin{matrix}\begin{matrix}the search word \\ significance value\end{matrix} = a corresponding predetermined word \\ weight \times the specific area occurrence value ,\end{matrix}$$
wherein the corresponding predetermined word weight is log (a total number of documents/the number of documents in which the word candidate occurs.

54. The apparatus for processing text data according to claim 45 wherein said search word selection unit further determines a search word significance value based upon a following equation:
$$\begin{matrix}\begin{matrix}the search word \\ significance value\end{matrix} = a corresponding predetermined word \\ weight \times the specific area occurrence value \times \\ a number of occurrences of the word \\ candidate within the text data .\end{matrix}$$

55. The apparatus for processing text data according to claim 45 further comprising a text selection unit connected to said specific area occurrence determination unit for selecting search words from the word candidates based upon the specific area occurrence value, said text selection unit extracting sentences from the predetermined text database based upon the selected search words.

56. The apparatus for processing text data according to claim 45 further comprising a keyword extraction unit connected to said specific area occurrence determination unit for selecting keywords from the word candidates based upon the specific area occurrence value.

57. The apparatus for processing text data according to claim 45 further comprising:
a keyword extraction unit connected to said specific area occurrence determination unit for selecting keywords from the word candidates based upon the specific area occurrence value; and
a summary generation unit connected to said keyword extraction unit for generating a summary from the predetermined text database based upon the selected keywords.

58. The apparatus for processing text data according to claim 45 further comprising:
a classification keyword selection unit connected to said specific area occurrence determination unit for selecting classification keywords from the word candidates based upon the specific area occurrence value; and
a classification unit connected to said classification keyword selection unit for classifying the predetermined text database based upon the selected classification keywords.

59. The apparatus for processing text data according to claim 45 further comprising:
a database occurrence determination unit connected to said search word selection unit for determining a first text database occurrence value of the word candidates in a first text database and a second text database occurrence value of the word candidates in a second text database, said database occurrence determination unit further determining a database occurrence value based upon the first text database occurrence value and the second text database occurrence value in a predetermined manner, wherein said search word selection unit selects search words from the word candidates based upon in part the database occurrence value; and
a text selection unit connected to said search word selection unit for extracting sentences from the predetermined text database based upon the selected search words.

60. The apparatus for processing text data according to claim 59 wherein said database occurrence determination unit determines the database occurrence value based upon a following equation:
$$\begin{matrix}\begin{matrix}the database \\ occurrence value\end{matrix} = ( the second text database occurrence value / \\ a total number of documents in the second \\ text database ) - ( the first text database \\ occurrence value / a total number of \\ documents in the first text database ) .\end{matrix}$$

61. The apparatus for processing text data according to claim 59 wherein said database occurrence determination unit determines the database occurrence value based upon a following equation:
$$\begin{matrix}\begin{matrix}the database \\ occurrence value\end{matrix} = ( the second text database occurrence value / \\ a total number of documents in the second \\ text database ) / ( the first text database \\ occurrence value / a total number of \\ documents in the first text database ) .\end{matrix}$$

62. The apparatus for processing text data according to claim 45 wherein said search word selection unit further determines a search word significance value based upon a following equation:
$$\begin{matrix}\begin{matrix}the search word \\ significance value\end{matrix} = the corresponding predetermined word \\ weight \times the database occurrence value ,\end{matrix}$$
wherein the corresponding predetermined word weight is log (a total number of documents/the number of documents in which the word candidate occurs).

63. A apparatus for processing text data, comprising:
an input unit for inputting text data;
a search word selection unit connected to said input unit for parsing the text data into word candidates, said search word selection unit removing predetermined words from the word candidates;
a database occurrence determination unit connected to said search word selection unit for determining a first text database occurrence value of the word candidates in a first text database and a second text database occurrence value of the word candidates in a second text database, said database occurrence determination unit further determining a database occurrence value based upon the first text database occurrence value and the second text database occurrence value in a predetermined manner, wherein said search word selection unit selects search words from the word candidates based upon in part the database occurrence value; and
a text selection unit connected to said search word selection unit for extracting sentences from the predetermined text database based upon the selected search words.

64. The apparatus for processing text data according to claim 63 wherein said database occurrence determination unit determines the database occurrence value based upon a following equation:
$$\begin{matrix}\begin{matrix}the database \\ occurrence value\end{matrix} = ( the second text database occurrence value / \\ a total number of documents in the second \\ text database ) - ( the first text database \\ occurrence value / a total number of \\ documents in the first text database ) .\end{matrix}$$

65. The apparatus for processing text data according to claim 63 wherein said database occurrence determination unit determines the database occurrence value based upon a following equation:
$$\begin{matrix}\begin{matrix}the database \\ occurrence value\end{matrix} = ( the second text database occurrence value / \\ a total number of documents in the second \\ text database ) / ( the first text database \\ occurrence value / a total number of \\ documents in the first text database ) .\end{matrix}$$

66. The apparatus for processing text data according to claim 63 wherein said search word selection unit further determines a search word significance value based upon a following equation:
$$\begin{matrix}\begin{matrix}the search word \\ significance value\end{matrix} = the corresponding predetermined word \\ weight X the database occurrence value ,\end{matrix}$$
wherein the corresponding predetermined word weight is log (a total number of documents/the number of documents in which the word candidate occurs).
